(19) United States
(12) Patent Application Publication
(10) Pub. No.: US 2026/0064257 A1
(43) Pub. Date: Mar. 5, 2026

(54) METHOD AND APPARATUS FOR OBTAINING STYLIZED IMAGE, AND DEVICE

(71) Applicant: Beijing Zitiao Network Technology Co., Ltd., Beijing (CN)

(72) Inventors: Jiaju XU, Beijing (CN); Linxi YE, Beijing (CN); Siming CHEN, Beijing (CN); Shuzhan YUAN, Beijing (CN); Hanqi WANG, Beijing (CN); Lin WANG, Beijing (CN); Jie YANG, Beijing (CN)

(21) Appl. No.: 19/312,574

(22) Filed: Aug. 28, 2025

(30) Foreign Application Priority Data
Aug. 30, 2024 (CN) 202411215346.3

(51) Int. Cl. G06F 3/04845; G06F 3/0482; G06F 3/04847; G06T 11/60

(52) U.S. Cl. CPC G06F 3/04845; G06F 3/0482; G06F 3/04847; G06T 11/60; G06T 2200/24

(57) ABSTRACT

The present disclosure provides a method and an apparatus for obtaining a stylized image, a computing device, a computer-readable storage medium, and a computer program product. The method includes: displaying a first interface, where the first interface includes an image with a style and a graphic element for triggering editing of the style, and the image with the style is generated by applying the style to a source image; displaying a second interface in response to receiving a selection of the graphic element, where the second interface includes at least one operating area for adjusting the style; receiving a user operation within the at least one operating area to adjust the style; and obtaining an image with the adjusted style in response to receiving confirmation of the user operation.

### CROSS-REFERENCE TO RELATED APPLICATION(S)

This application claims priority to Chinese Application No. 202411215346.3, filed on Aug. 30, 2024, the disclosure of which is incorporated herein by reference in its entirety.

### FIELD

The present disclosure relates to the field of computer technology, and more specifically, to a method and an apparatus for obtaining a stylized image, a computing device, a computer-readable storage medium, and a computer program product.

### BACKGROUND

In the current digital era, model-based generative technology is permeating and transforming our lifestyles and work patterns at an unprecedented pace, especially in the field of image processing, where the application of generative technology demonstrates immense potential and boundless creative possibilities. For example, generative models enable image-to-image translation that alters the style of source images to achieve diverse artistic effects.

### SUMMARY

In view of this, the present disclosure provides a method and an apparatus for obtaining a stylized image, a computing device, a computer-readable storage medium, and a computer program product.

According to a first aspect of the present disclosure, there is provided a method for obtaining a stylized image, including: displaying a first interface, where the first interface includes an image with a style and a graphic element for triggering editing of the style, and the image with the style is generated by applying the style to a source image; displaying a second interface in response to receiving a selection of the graphic element, where the second interface includes at least one operating area for adjusting the style; receiving a user operation within the at least one operating area to adjust the style; and obtaining an image with the adjusted style in response to receiving confirmation of the user operation.

According to a second aspect of the present disclosure, there is provided an apparatus for obtaining a stylized image, including: a first-interface display unit, configured to display a first interface, where the first interface includes an image with a style and a graphic element for triggering editing of the style, and the image with the style is generated by applying the style to a source image; a second-interface display unit, configured to display a second interface in response to receiving a selection of the graphic element, where the second interface includes at least one operating area for adjusting the style; a style adjustment unit, configured to receive a user operation within the at least one operating area to adjust the style; and an image obtaining unit, configured to obtain an image with the adjusted style in response to receiving confirmation of the user operation.

According to a third aspect of the present disclosure, there is provided a computing device, including: at least one processing unit; and at least one memory, where the at least one memory is coupled to the at least one processing unit, and stores instructions executable by the at least one processing unit, and the instructions, when executed by the at least one processing unit, cause the computing device to perform the method according to the first aspect of the present disclosure.

According to a fourth aspect of the present disclosure, there is provided a non-transitory computer storage medium, including machine-executable instructions that, when executed by a device, cause the device to perform the method according to the first aspect of the present disclosure.

According to a fifth aspect of the present disclosure, there is provided a computer program product, including machine-executable instructions that, when executed by a device, cause the device to perform the method according to the first aspect of the present disclosure.

It should be understood that the content described in the summary is neither intended to identify key or essential features of the embodiments of the present disclosure, nor is it intended to limit the scope of the present disclosure. Other features of the present disclosure will be readily understood from the following description.

### BRIEF DESCRIPTION OF THE DRAWINGS

The foregoing and other objectives, features, and advantages of embodiments of the present disclosure will be easier to understand with reference to the following detailed descriptions of the accompanying drawings. In the accompanying drawings, a plurality of embodiments of the present disclosure will be described in an exemplary and non-limiting manner, in which:

FIG. 1 is a schematic diagram of an example environment in which embodiments of the present disclosure can be implemented;

FIG. 2A is a schematic diagram of a third interface according to an embodiment of the present disclosure;

FIG. 2B is a schematic diagram of an interface displaying a plurality of style templates according to an embodiment of the present disclosure;

FIG. 2C is a schematic diagram of a first interface according to an embodiment of the present disclosure;

FIG. 2D is a schematic diagram of a second interface according to an embodiment of the present disclosure;

FIG. 2E is a schematic diagram of an interface for obtaining optimized keywords according to an embodiment of the present disclosure;

FIG. 2F is a schematic diagram of an interface for obtaining an image with an adjusted style according to an embodiment of the present disclosure;

FIG. 3 is a flowchart of a method for obtaining a stylized image according to an embodiment of the present disclosure;

FIG. 4 is a block diagram of an apparatus for obtaining a stylized image according to an embodiment of the present disclosure; and

FIG. 5 is a block diagram of an electronic device according to an embodiment of the present disclosure.

Throughout the accompanying drawings, the same or similar reference numerals denote the same or similar elements.

### DETAILED DESCRIPTION OF EMBODIMENTS

It can be understood that the data involved in the technical solutions (including, but not limited to, the data itself and the access to or use of the data) shall comply with the requirements of corresponding laws, regulations, and relevant provisions.

It can be understood that before the use of the technical solutions disclosed in the embodiments of the present disclosure, the user shall be informed of the type, scope of use, use scenarios, etc., of personal information involved in the present disclosure in an appropriate manner in accordance with the relevant laws and regulations, and the authorization of the user shall be obtained.

For example, upon reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree”or “disagree”to provide the personal information to the electronic device.

It can be understood that the foregoing process of notifying and obtaining the authorization of the user is only illustrative and does not constitute a limitation on the implementations of the present disclosure, and other manners that satisfy the relevant laws and regulations may also be applied in the implementations of the present disclosure.

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object, unless otherwise explicitly defined. Other explicit and implicit definitions may also be included below.

An image style refers to distinctive visual features or visual elements of an image, such as color palette, linework, geometric forms, textural patterns, and compositional arrangements. A combination of these attributes constitutes the overall visual identity of the image, enabling perceptual differentiation and categorical classification. For instance, this can be interpreted through the lens of artistic expression forms, encompassing painting styles, photographic genres, and design paradigms, etc. Different art forms have different creation methods and means of expression, resulting in different stylistic characteristics. The style of an image may also manifest through its engineered emotional resonance and atmospheric qualities. An image can create a particular emotional atmosphere such as joy, sadness, mystery, horror, etc. based on its color and composition. The image style can also be defined or distinguished from other aspects.

Significant advances have been made in image generation technology, such as the ability to automatically generate high-quality images based on deep learning algorithms, however, many applications in the current market still face some limitations and challenges. These limitations are mainly reflected in a centralized mode of server-side processing, that is, the user uploads an image to a server, and a server-side generative model performs complex image processing tasks (such as image style transfer and content generation), and then returns a result to a client for displaying after the processing is completed. Although this mode can ensure efficient processing and stable quality, it also introduces issues such as rigid style options and a lack of playability. In addition, because the style is a non-real-time effect, it is also a challenge to composite the style with other effects.

Existing image-to-image generation technologies only provide users with limited operational flexibility. Current implementations typically constrain users to controlling output of the generative models through source images combined with keywords (e.g., “cartoon style”, and “oil painting style”), which restricts creative expression capabilities of uses.

To solve or alleviate the foregoing problem and/or other potential problems, an embodiment of the present disclosure provides a method for obtaining a stylized image. This method enhances the playability of style-based image editing by allowing further customization of the applied styles of generated images. In this specification, images include still images, graphics, videos, or any other form of visualization data.

Basic principles and implementations of the present disclosure are illustrated below with reference to the accompanying drawings. It should be understood that exemplary embodiments are given only to enable those skilled in the art to better understand and thus implement the embodiments of the present disclosure, and are not intended to limit the scope of the present disclosure in any manner.

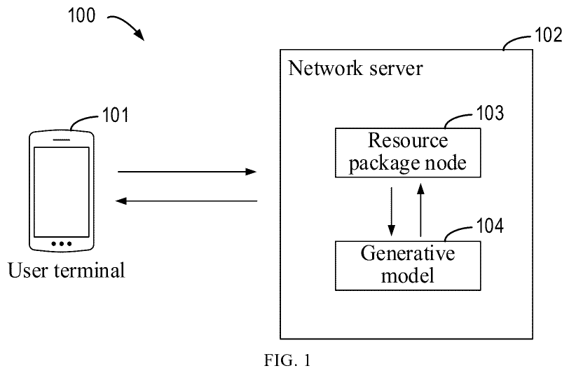

FIG. 1 is a schematic diagram of an environment 100 in which a plurality of embodiments of the present disclosure can be implemented. As shown in FIG. 1, the environment 100 includes a user terminal 101 operable by a user and a network server 102. Optionally, the user terminal 101 may specifically be a smartphone, a tablet computer, a portable computer, a smart television, an in-vehicle computer, a wearable device (for example, a smart wristband or a smart watch) that has a display function. A browser or various applications (including system applications and third-party applications, such as an image editing application) may be installed on the user terminal 101. The user terminal can obtain information through applications, applets, web pages, etc., and display the information on a display of the user terminal. The user terminal 101 can support a text input, a voice input, etc.

The network server 102 may be a separate physical network server, may be a network server cluster or distributed system of a plurality of physical network servers, or may be a cloud network server which provides cloud services, cloud databases, cloud computing, cloud functions, cloud storage, network services, cloud communication, middleware services, domain name services, security services, CDNs, and basic cloud computing services such as big data and artificial intelligence platforms.

As shown in FIG. 1, the network server 102 may include a resource package node 103 and a generative model 104. The resource package node 103 and the generative model 104 may be deployed on a local server or remotely. The generative model 104 may alternatively be deployed outside the network server 102, for example, from a third-party service provider. This is not limited in the present disclosure.

The user terminal 101 and the network server 102, the resource package node 103 and the generative model 104 can all be communicatively connected through a network. The network may be a wired network or a wireless network. For example, the network may be an electronic network capable of implementing a data exchange function, for example, a local area network (LAN), a metropolitan area network (MAN), a wide area network (WAN), a cellular data communication network, etc.

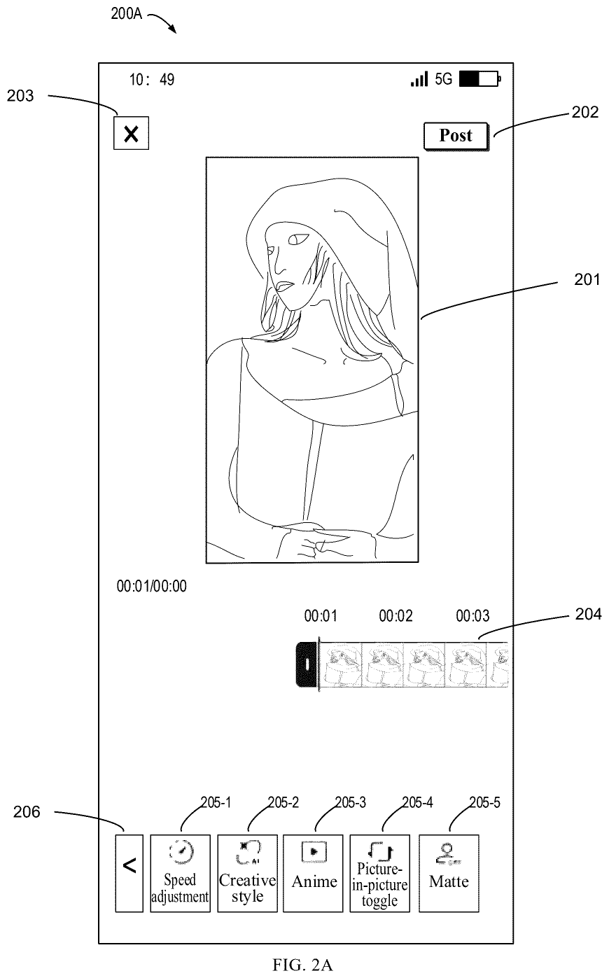

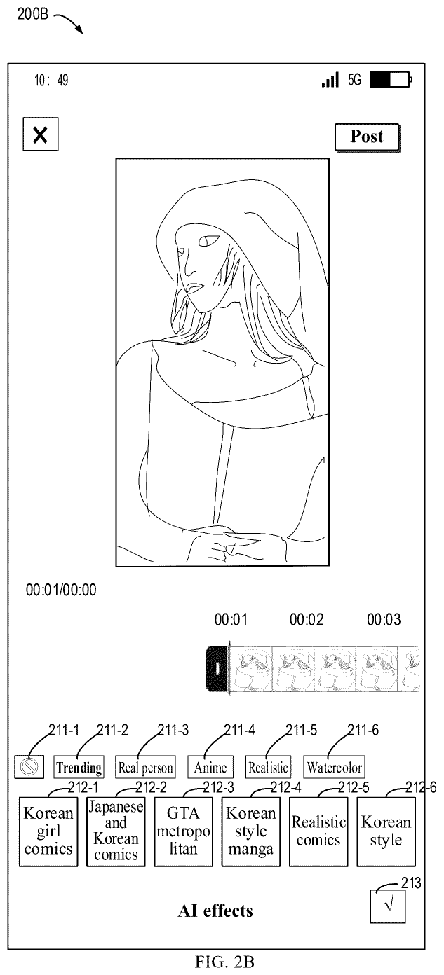

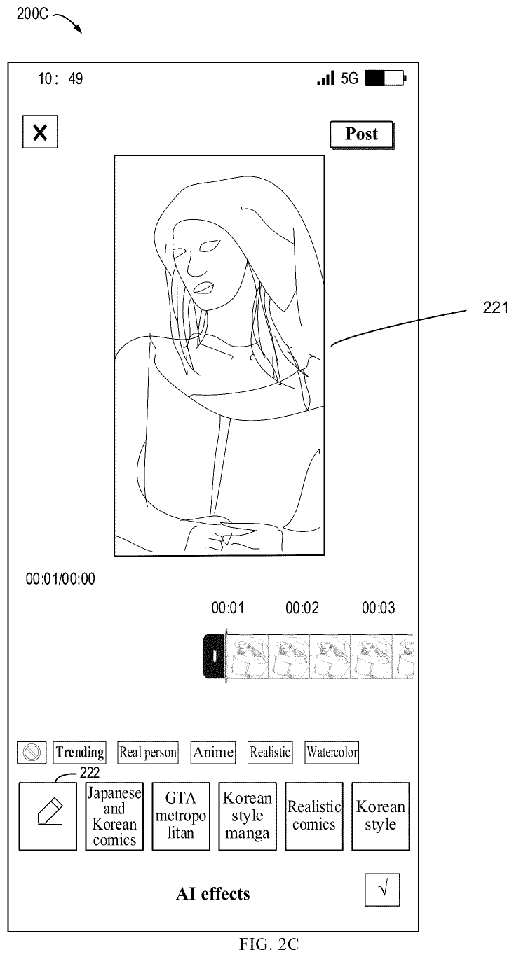

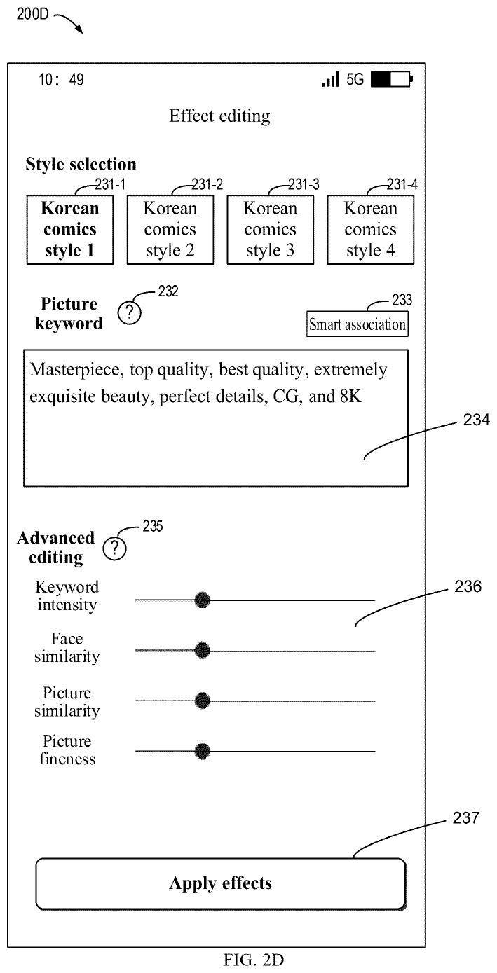

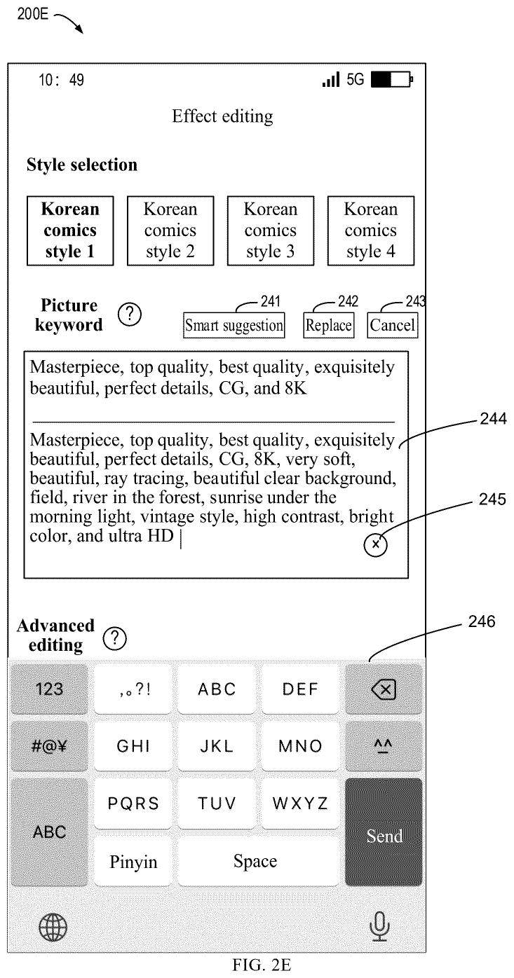

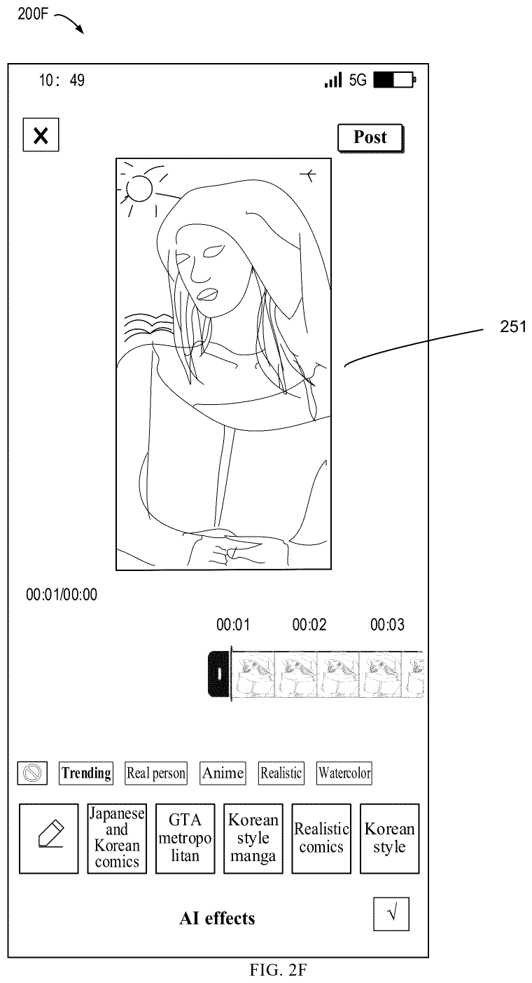

As shown in FIG. 1, the user terminal 101 can transmit data, information, and services with the network server 102 through the network. For example, different styles may be configured as resource packages and stored in the resource package node 103. In some embodiments, the resource package may include parameters of a corresponding style, the parameters may be used as prompts for the generative model, and the generative model 104 uses these parameters to generate an image with the style based on a source image. The parameters may include text, numbers, or any other form of data. The user terminal 101 may obtain resource packages that are in one-to-one correspondence with different styles from the resource package node 103 for the user to adjust the configuration of the style. Correspondingly, the user terminal 101 may send the resource package with the adjusted configuration to the network server 102, and forward the resource package to the generative model 104 through the resource package node 103, so as to generate an image with an adjusted style. Then the generative model 104 may send the image with the adjusted style to the user terminal 101. The following describes in detail a process of obtaining a stylized image with reference to FIG. 2A to FIG. 2F. It should be noted that the terminal interfaces and elements thereof shown in FIG. 2A to FIG. 2F are only exemplary, and the embodiments of the present disclosure may be implemented on different devices or interfaces without departing from the scope of the present disclosure.

FIG. 2A is a schematic diagram of a third interface 200A to an embodiment of the present disclosure. In some embodiments, the third interface 200A is displayed as an interface of a mobile terminal application. As shown in FIG. 2A, the third interface 200A may include a status bar display component, a source image area, and an editing function area from top to bottom. The status bar display component may include a time status, a mobile phone signal status, and a battery level status from left to right. The source image area may include a source image 201, a button 202 for posting an image, a button 203 for canceling image editing, and a timeline 204.

For example, the user can record a short video by using an image editing application stored on the mobile phone terminal, or capture a live picture including both still photos and short video clips, and then tap the Edit button to enter the third interface 200A to start an image editing operation. The user can slide the timeline 204 to select the source image 201 to be edited. The user may also directly tap the button 202 for posting an image to post the unedited source image 201, or tap the button 203 for canceling image editing to re-perform shooting or recording.

As shown in FIG. 2A, the editing function area may include a shift left button 206 and a plurality of buttons 205 with image editing functions from left to right. For example, the plurality of buttons 205 with image editing functions may include a speed adjustment button 205-1, a style button 205-2, an animation button 205-3, a picture-in-picture toggle button 205-4, and a matting button 205-5. The user can tap a button with a corresponding image editing function according to requirements, to display a further function menu. In some embodiments, when the user taps the style button 205-2, a plurality of style templates may be displayed on an application interface for the user to apply a style to the source image.

FIG. 2B is a schematic diagram of an interface 200B displaying a plurality of style templates according to an embodiment of the present disclosure. As shown in FIG. 2B, after the user taps the style button 205-2, the third interface 200A is replaced with a new interface 200B, and the lower editing function area is replaced with a plurality of style templates 212. Optionally, the plurality of style templates 212 may each include an effect name and an effect cover image.

In some embodiments, the plurality of style templates 212 may be displayed according to a category 211. For example, the category 211 may include unclassified 211-1 (that is, style canceled), trending 211-2, real person 211-3, anime 211-4, realistic 211-5, and watercolor 211-6. For example, under the trending 211-2 category, the following style templates may be included: Korean girl comics 212-1, Japanese and Korean comics 212-2, GTA metropolitan 212-3, Korean style manga 212-4, realistic comics 212-5, and Korean style 212-6. The interface 200B may also include a confirmation button 213 for confirming application of a style after the user selects or adjusts the style. In some embodiments, when the user select a style template for Korean girl comics 212-1, the application interface may display a preview image of a preset configuration to which the style template is applied.

FIG. 2C is a schematic diagram of a first interface 200C according to an embodiment of the present disclosure. As shown in FIG. 2C, in the first interface 200C, the source image 201 is replaced by the preview image 221 to which the style is applied, and the style template for Korean girl comics 212-1 is changed to display a graphic element 222 representing editability. In some embodiments, after the user selects the style template for Korean girl comics 212-1, a loading time is required for generation of the preview image 221. Optionally, during the loading time, the effect cover image for Korean girl comics 212-1 may display a loading effect, and the loading effect may also be displayed above the timeline 204. For example, a bubble prompt “Generating . . . x % complete”may be displayed.

Optionally, the user can also tap the bubble to cancel the style generation process. For example, after the user taps the bubble prompt, the application interface may display a pop-up message “Do you want to cancel style generation?” Upon further confirmation by the user, the style generation process is terminated immediately, and the preview image 221 is not displayed on the application interface. In the process of terminating style generation, the user may also delete the source image. After the source image is deleted, the bubble prompt showing the progress will also be closed. Optionally, in the style generation process, when the user taps another style template, the application interface may display information that the operation is invalid, for example, a pop-up message “Generation is in progress. Please wait”.

In some embodiments, the user may tap the graphic element 222 to edit the style template. FIG. 2D is a schematic diagram of a second interface 200D according to an embodiment of the present disclosure. As shown in FIG. 2D, the second interface 200D may include a preset configuration area, a keyword area, and a parameter adjustment area from top to bottom. The preset configuration area may include a plurality of preset configurations 231. Optionally, the plurality of preset configurations 231 may each include a configuration name and an effect cover image. For example, the plurality of preset configurations 231 may include: Korean comics style 1 231-1, Korean comics style 2 231-2, Korean comics style 3 231-3, and Korean comics style 4 231-4.

The keyword area may include a prompt button 232, a smart suggestion button 233, and a keyword input field 234. The user may tap the prompt button 232 to obtain the prompt information about the picture keyword, for example, the prompt information can be a bubble pop-up window with the text “Please describe the content in the picture, such as the main picture, composition, and style”. The user may enter some keywords in the keyword input field 234 by using a keyboard, and may enter keywords by using a voice input function. This is not limited in the present disclosure. After entering the keywords, the user may also tap the smart suggestion button 233 to obtain optimized keywords.

FIG. 2E is a schematic diagram of an interface 200E for obtaining optimized keywords according to an embodiment of the present disclosure. As shown in FIG. 2E, after the user enters the keywords and taps the smart suggestion button 233, the application interface will display an optimized-keyword area 244, a smart suggestion button 241, a replace button 242, and a cancel button 243. For example, after the user enters initial keywords “masterpiece, top quality, best quality, exquisitely beautiful, perfect details, CG, and 8K” through the keyboard 246 in the keyword input field 234 on the interface 200D and taps the smart suggestion button 233, the interface 200E will display the optimized keywords “masterpiece, top quality, best quality, exquisitely beautiful, perfect details, CG, 8K, very soft, beautiful, ray tracing, beautiful clear background, field, river in the forest, sunrise under the morning light, vintage style, high contrast, bright color, and ultra HD” in the optimized-keyword area 244. If the user is satisfied with the optimized keywords, the user may tap the replace button 242 on the interface 200E to replace the original keywords with the optimized keywords, after which the optimized-keyword area will disappear. On the contrary, if the user is not satisfied with the optimized keywords, the user may tap the smart suggestion button 241 on the interface 200E to regenerate optimized keywords, or tap the cancel button 245 to cancel the generated optimized keywords. The user may also tap the cancel button 243 to remove the initial keywords and the optimized keywords.

Return to FIG. 2D. The preset configuration area may include a prompt button 235 and a number of parameter adjusters 236. For example, a plurality of parameters may include keyword intensity, face similarity, picture similarity, and picture fineness, and the user may tap the prompt button 235 to obtain prompt information about the plurality of parameters. For example, the prompt information may be “keyword intensity: 0-100%, the larger the value, the greater the effect of the text; face similarity: 0-100%, the larger the value, the higher the similarity to the original face; picture similarity: 0-100%, structural similarity to the input image; and picture fineness: 0-100%, the number of steps for generating the image”.

Optionally, each preset configuration 231 may have different adjustable parameters. After adjusting values of the plurality of parameters, the user may switch back to the preset configuration 231. At this time, the user may compare the current preset configuration with the new configuration to check whether they have same parameters. If yes, the values are synchronized; or if no, default values in the new configuration are used.

After adjusting the style configuration, the user may tap the Apply effects button 237 to obtain a stylized image. FIG. 2F is a schematic diagram of an interface 200F for obtaining an image with an adjusted style according to an embodiment of the present disclosure. As shown in FIG. 2F, the application interface will jump to the first interface and replace the preview image 221 with a stylized image 251. The user can further add other real-time effects, for example, a texture, to the image 251. In the style template area on the interface 200F, the user may save previously edited parameters as a style template. The user may tap the style template again to display the previously edited parameters.

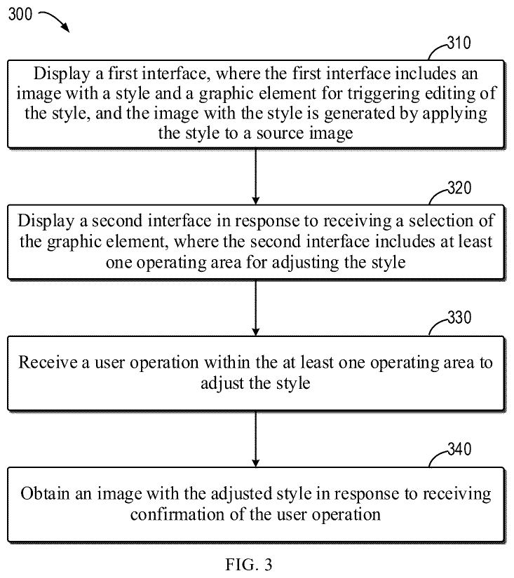

The following further describes the process of obtaining an image with an adjusted style with reference to FIG. 3. FIG. 3 is a schematic flowchart of a method 300 for obtaining a stylized image according to some embodiments of the present disclosure. In some embodiments, the method 300 may be implemented by, for example, the network server 102 shown in FIG. 1. It should be understood that the method 300 may further include additional actions not shown and/or may omit actions shown, and the scope of the present disclosure is not limited in this regard.

As shown in FIG. 3, at block 310, the method 300 may include: displaying a first interface, where the first interface includes an image with a style and a graphic element for triggering editing of the style, and the image with the style is generated by applying the style to a source image.

In some embodiments, that first interface may be jumped from the third interface. The user terminal 101 may first display the third interface, where the third interface includes the source image and a second control for applying a style. The user terminal 101 may display a plurality of style templates in response to receiving a selection of the second control by the user. The user terminal 101 may display a first interface in response to receiving a selection of one of the plurality of style templates by the user.

In some embodiments, each of the plurality of style templates corresponds to one resource package. The resource packages may be sent by the generative model 104 in FIG. 1 to the user terminal 101 through the resource package node 103. The user terminal 101 may obtain the resource packages for the plurality of styles, where each resource package includes configuration parameters for the corresponding style.

At block 320, the method 300 may include: displaying a second interface in response to receiving a selection of the graphic element, where the second interface includes at least one operating area for adjusting the style. In some embodiments, the at least one operating area may include a keyword area. In some embodiments, the keyword area may further include a first control associated with keyword optimization.

In some embodiments, the at least one operating area may also include a preset configuration area. The preset configuration area includes a plurality of preset configurations. In some embodiments, the at least one operating area may also include a parameter adjustment area, where the parameter adjustment area includes a plurality of parameters associated with a style. Optionally, the parameters may include at least one of keyword intensity, face similarity, picture similarity, and picture fineness.

At block 330, the method 300 may include: receiving a user operation within the at least one operating area to adjust the style. In some embodiments, the user operation may include: entering keywords in the keyword area, where the keywords include a prompt for the style; triggering the first control to obtain optimized keywords based on the entered keywords; selecting one of the plurality of preset configurations in the preset configuration area to change the style; and adjusting the plurality of parameters in the parameter adjustment area.

At block 340, the method 300 may include: obtaining an image with the adjusted style in response to receiving confirmation of the user operation. In some embodiments, after the user adjusts the configuration in the operating area, configuration parameters of the corresponding style template will also be modified. The user terminal 101 may provide the source image and the resource package including the modified configuration parameters to the generative model 104 to obtain the image with the modified style that is generated by the generative model 104.

In some embodiments, the user may also add one or more real-time effects to the image with a style. In the method 300, the generative model 104 may send the resource package with a custom configuration to the user terminal 101, and the user terminal 101 may adjust the configuration in the resource package and return the resource package to the generative model 104. In addition, the network server 102 may serve as a proxy to mount the image with the style onto a data model for coexistence with the source image. Therefore, the non-real-time action of adding a style to an image may be compatible with real-time effects. During reproduction of effects of data, the presence of the proxy node can be detected, so as to automatically composite the style with the previous real-time effects.

The foregoing has described exemplary embodiments of the present disclosure with reference to FIG. 1 to FIG. 3. In contrast to an existing solution in which a style is used to edit an image, in the solution of the present disclosure for obtaining a stylized image, a custom style adjustment may be further performed on the image that is generated by applying a style, thereby enhancing playability of using a style for image editing.

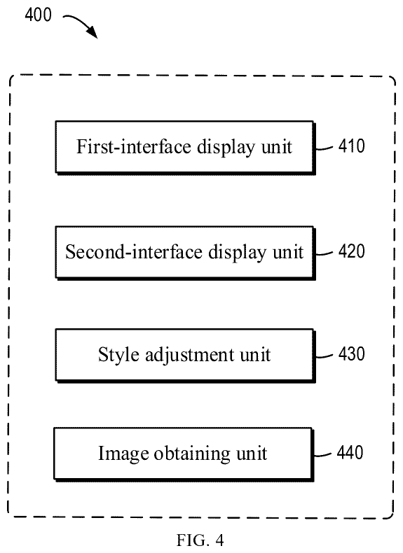

FIG. 4 is a schematic block diagram of an apparatus 400 for obtaining a stylized image according to an embodiment of the present disclosure. As shown in FIG. 4, the apparatus 400 includes: a first-interface display unit 410, a second-interface display unit 420, a style adjustment unit 430, and an image obtaining unit 440.

In some embodiments, the first-interface display unit is configured to display a first interface, where the first interface includes an image with a style and a graphic element for triggering editing of the style, and the image with the style is generated by applying the style to a source image; the second-interface display unit is configured to display a second interface in response to receiving a selection of the graphic element, where the second interface includes at least one operating area for adjusting the style; the style adjustment unit is configured to receive a user operation within the at least one operating area to adjust the style; and the image obtaining unit is configured to obtain an image with the adjusted style in response to receiving confirmation of the user operation.

It should be noted that more actions or steps shown with reference to FIG. 1 to FIG. 3 may be implemented by the apparatus 400 shown in FIG. 4. For example, the apparatus 400 may include more modules or units to implement the actions or steps described above, or some units or modules shown in FIG. 4 may be further configured to implement the actions or steps described above. Repeated descriptions are not provided herein.

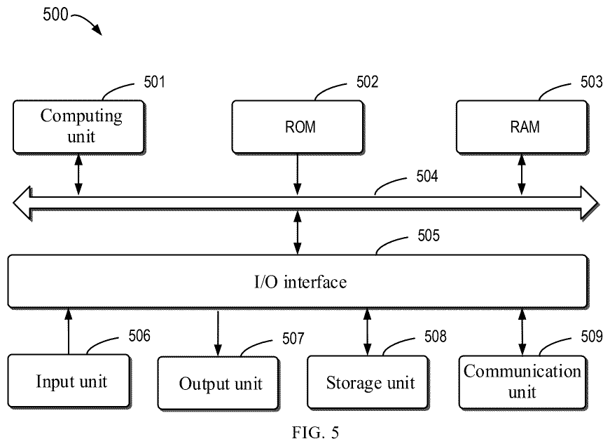

FIG. 5 is a schematic block diagram of an example device 500 that may be used to implement the embodiments of the present disclosure. As shown in the figure, the device 500 includes a computing unit 501 that may perform a variety of appropriate actions and processing according to computer program instructions stored in a read-only memory (ROM) 502 or computer program instructions loaded from a storage unit 506 into a random-access memory (RAM) 503. The RAM 503 may further store various programs and data required for the operation of the device 500. The computing unit 501, the ROM 502, and the RAM 503 are connected to one another through a bus 504. An input/output (I/O) interface 505 is also connected to the bus 504.

A plurality of components in the device 500 are connected to the I/O interface 505, including: an input unit 506, for example, a keyboard or a mouse; an output unit 507, for example, various displays or speakers; a storage unit 508, for example, a magnetic disk or an optical disk; and a communication unit 509, for example, a network interface card, a modem, or a wireless communication transceiver. The communication unit 509 allows the device 500 to exchange information/data with other devices over a computer network, for example, the Internet and/or various telecommunication networks.

The computing unit 501 may be various general-purpose and/or special-purpose processing components with processing and computing capabilities. Some examples of the computing unit 501 include but are not limited to a central processing unit (CPU), a graphics processing unit (GPU), various special-purpose artificial intelligence (AI) computing chips, various computing units running machine learning model algorithms, a digital signal processor (DSP), and any appropriate processor, controller, microcontroller, etc. The computing unit 501 performs various methods and processing described above, for example, the method 300. For example, in some embodiments, the method 300 may be implemented as a computer software program tangibly contained in a machine-readable medium such as the storage unit 508. In some embodiments, some or all of the computer programs may be loaded into and/or installed onto the device 500 through the ROM 502 and/or the communication unit 509. When the computer program is loaded onto the RAM 503 and executed by the computing unit 501, one or more steps of the method 300 described above can be performed. Alternatively, in other embodiments, the computing unit 501 may be configured, in any other appropriate manner (for example, by means of firmware), to perform the method 300.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random-access memory (RAM), a read-only memory (ROM), an erasable programmable read-only memory (EPROM) (or a flash memory), a static random-access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal, such as a radio wave or another freely propagating electromagnetic wave, an electromagnetic wave propagating through a waveguide or another transmission medium (for example, an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected through the Internet with the aid of an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions marked in the blocks may occur in a sequence different from that marked in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a special-purpose hardware-based system that executes specified functions or actions, or may be implemented by a combination of special-purpose hardware and computer instructions.

Various embodiments of the present disclosure have been described above. The foregoing descriptions are exemplary, not exhaustive, and are not limited to the disclosed embodiments. Many modifications and variations are apparent to a person of ordinary skill in the art without departing from the scope and spirit of the described embodiments. Selection of terms used in this specification is intended to optimally explain principles and actual application of the embodiments, or technical improvements of technology in the market, or to enable other persons of ordinary skill in the art to understand the embodiments disclosed in this specification.

I/We claim:

1. A method for obtaining a stylized image, comprising:
displaying a first interface, wherein the first interface comprises an image with a style and a graphic element for triggering editing of the style, and the image with the style is generated by applying the style to a source image;
displaying a second interface in response to receiving a selection of the graphic element, wherein the second interface comprises at least one operating area for adjusting the style;
receiving a user operation within the at least one operating area to adjust the style; and
obtaining an image with the adjusted style in response to receiving confirmation of the user operation.

2. The method according to claim 1, wherein the at least one operating area comprises a keyword area, and the user operation comprises:
entering keywords in the keyword area, wherein the keywords comprise a prompt for the style.

3. The method according to claim 2, wherein the keyword area further comprises a first control associated with keyword optimization, and the user operation further comprises:
triggering the first control to obtain optimized keywords based on the entered keywords.

4. The method according to claim 3, wherein the at least one operating area further comprises a preset configuration area, the preset configuration area comprises a plurality of preset configurations, and the user operation further comprises:
selecting one of the plurality of preset configurations to change the style.

5. The method according to claim 4, wherein the at least one operating area further comprises a parameter adjustment area, wherein the parameter adjustment area comprises a plurality of parameters associated with the style, and the user operation further comprises:
adjusting the plurality of parameters.

6. The method according to claim 5, wherein the plurality of parameters comprise at least one of keyword intensity, face similarity, picture similarity, and picture fineness.

7. The method according to claim 1, wherein the method further comprises:
displaying a third interface, wherein the third interface comprises the source image and a second control for applying a style;
displaying a plurality of style templates in response to receiving a selection of the second control; and
displaying the first interface in response to receiving a selection of a style template in the plurality of style templates.

8. The method according to claim 1, further comprising:
obtaining resource packages for a plurality of styles, wherein each resource package comprises configuration parameters of the corresponding style.

9. The method according to claim 8, wherein the obtaining an image with the adjusted style in response to receiving confirmation of the user operation comprises:
modifying the configuration parameters of the style based on the user operation; and
providing the source image and the resource package comprising the modified configuration parameters to a generative model, to obtain the image with the adjusted style that is generated by the generative model.

10. The method according to claim 1, wherein the image with the style further comprises at least one real-time effect, and the method further comprises:
compositing the at least one real-time effect with the image with the adjusted style.

11. A device comprising:
at least one processing unit; and
at least one memory, wherein the at least one memory is coupled to the at least one processing unit, and stores instructions for execution by the at least one processing unit, and the instructions, when executed by the at least one processing unit, cause the computing device to perform a method comprising:
displaying a first interface, wherein the first interface comprises an image with a style and a graphic element for triggering editing of the style, and the image with the style is generated by applying the style to a source image;
displaying a second interface in response to receiving a selection of the graphic element, wherein the second interface comprises at least one operating area for adjusting the style;
receiving a user operation within the at least one operating area to adjust the style; and
obtaining an image with the adjusted style in response to receiving confirmation of the user operation.

12. The device according to claim 11, wherein the at least one operating area comprises a keyword area, and the user operation comprises:
entering keywords in the keyword area, wherein the keywords comprise a prompt for the style.

13. The device according to claim 12, wherein the keyword area further comprises a first control associated with keyword optimization, and the user operation further comprises:
triggering the first control to obtain optimized keywords based on the entered keywords.

14. The device according to claim 13, wherein the at least one operating area further comprises a preset configuration area, the preset configuration area comprises a plurality of preset configurations, and the user operation further comprises:
selecting one of the plurality of preset configurations to change the style.

15. The device according to claim 14, wherein the at least one operating area further comprises a parameter adjustment area, wherein the parameter adjustment area comprises a plurality of parameters associated with the style, and the user operation further comprises:
adjusting the plurality of parameters.

16. The device according to claim 15, wherein the plurality of parameters comprise at least one of keyword intensity, face similarity, picture similarity, and picture fineness.

17. The device according to claim 11, wherein the method further comprises:
displaying a third interface, wherein the third interface comprises the source image and a second control for applying a style;
displaying a plurality of style templates in response to receiving a selection of the second control; and
displaying the first interface in response to receiving a selection of a style template in the plurality of style templates.

18. The device according to claim 11, the method further comprising:
obtaining resource packages for a plurality of styles, wherein each resource package comprises configuration parameters of the corresponding style.

19. The device according to claim 18, wherein the obtaining an image with the adjusted style in response to receiving confirmation of the user operation comprises:
modifying the configuration parameters of the style based on the user operation; and
providing the source image and the resource package comprising the modified configuration parameters to a generative model, to obtain the image with the adjusted style that is generated by the generative model.

20. A non-transitory computer storage medium, comprising machine-executable instructions that, when executed by a device, cause the device to perform a method comprising:
displaying a first interface, wherein the first interface comprises an image with a style and a graphic element for triggering editing of the style, and the image with the style is generated by applying the style to a source image;
displaying a second interface in response to receiving a selection of the graphic element, wherein the second interface comprises at least one operating area for adjusting the style;
receiving a user operation within the at least one operating area to adjust the style; and
obtaining an image with the adjusted style in response to receiving confirmation of the user operation.
